(19) United States
(12) Patent Application Publication
(10) Pub. No.: US 2013/0239069 A1
(43) Pub. Date: Sep. 12, 2013

(54) CONTROL METHOD FOR MOBILE DEVICE USING SETTING PATTERN AND MOBILE DEVICE

(71) Applicant: PANTECH CO., LTD, Seoul (KR)

(72) Inventors: Woo Kyung JEONG, Seoul (KR); Hey Joo Chang, Seoul (KR); Young Ok Jun, Seoul (KR)

(73) Assignee: Pantech Co., Ltd, Seoul (KR)

(21) Appl. No.: 13/758,363

(22) Filed: Feb. 4, 2013

(30) Foreign Application Priority Data
Mar. 6, 2012 (KR) 10-2012-0022743

(51) Int. Cl. G06F 3/01

(52) U.S. Cl. CPC G06F 3/017
USPC 715/863

(57) ABSTRACT

A control method for a mobile device allows for manipulation of various features of a mobile device by inputting a touch pattern even if an application program is operating in a foreground of the mobile device. The control method includes: receiving a touch input signal; transferring the touch input signal to a software block of the mobile device and an application program; determining if the touch input signal corresponds to a setting pattern in the software block; and performing a set action corresponding to the setting pattern if the touch input signal corresponds to the setting pattern.

### CROSS-REFERENCE TO RELATED APPLICATION

This application claims priority from and the benefit under 35 U.S.C. §119 of Korean Patent Application No. 10-2012-0022743, filed on Mar. 6, 2012, which is incorporated by reference for all purposes as if fully set forth herein.

### BACKGROUND

1. Field

The following description relates to a control method for a mobile device using a setting pattern and a mobile device using the method.

2. Discussion of the Background

Along with the rapid development of processor technologies, the increase of memory capacities, and the development of multimedia coding technologies, mobile devices, is such as, smart phones and smart pads have more diversified features. Various kinds of application programs, such as, navigation, Instant Messenger Service (IMS), and schedulers, may operate on a mobile operating system (OS), and each application program may use hardware or software of the mobile device.

While a specific application program is operating, only features corresponding to an input in the application program are performed. In other words, every application program includes an input/output suitable for the purpose of that application program, and other features, such as, screen lighting settings, screen direction settings, and screen enlargement settings, which have no relation with the operation of that application program, may be differently defined in various application programs or may not be defined at all.

If not defined, for example, if using common commands, the execution of the application program may be interrupted, and the user may activate an environment setting widow, check a setting menu and change the settings, which may be inconvenient to the user. In addition, since various menus may be part of the setting menu, to change a specific setting the user may perform various operations to reach the specific setting which may increase user inconvenience.

### SUMMARY

Exemplary embodiments of the present invention provide a mobile device and a control method for a mobile device using a setting pattern to manipulate various features of the mobile device by inputting a touch pattern while an application program is operating in a foreground of the mobile device.

Additional features of the invention will be set forth in the description which follows, and in part will be apparent from the description, or may be learned by practice of the invention.

An exemplary embodiment of the present invention discloses a method for controlling a device, including: receiving a touch input; determining if the touch input is a set pattern corresponding to a set action of the device; executing the set action of the device, if the touch input corresponds to the set pattern.

An exemplary embodiment of the present invention also discloses a method for controlling a mobile device, comprising: receiving a touch input signal; transferring the touch input signal to a software block of the mobile device and to an application program; determining if the touch input signal corresponds to a setting pattern in the software block; and performing a set action corresponding to the setting pattern if the touch input signal corresponds to the setting pattern.

An exemplary embodiment of the present invention also discloses a mobile device, comprising: an input unit to receive a touch input signal; a setting pattern determining unit to determine if the touch input signal is a setting pattern; and a set action performing unit to execute a set action corresponding to the setting pattern, if the touch input signal corresponds to the setting action.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view of an operating system (OS) of a mobile device according to an exemplary embodiment of the present disclosure.

FIG. 2 is a schematic view of a delivery system of an input signal according to an exemplary embodiment of the present disclosure.

FIG. 3 is a schematic view of a mobile device according to an exemplary embodiment of the present disclosure.

FIG. 4 is a flowchart of a control method of a mobile device according to an exemplary embodiment of the present disclosure.

FIG. 5 is a diagram of a setting pattern according to an exemplary embodiment of the present disclosure.

FIG. 6 is a diagram of a setting pattern according to an exemplary embodiment of the present disclosure.

FIG. 7 is a diagram of a setting pattern according to an exemplary embodiment of the present disclosure.

FIG. 8 is a diagram of a setting pattern according to an exemplary embodiment of the present disclosure.

FIG. 9 is a diagram of a setting pattern according to an exemplary embodiment of the present disclosure.

FIG. 10 is a diagram of a setting pattern according to an exemplary embodiment of the present disclosure.

FIG. 11 is a diagram of a setting pattern according to an exemplary embodiment of the present disclosure.

FIG. 12 is a diagram of a setting pattern according to an exemplary embodiment of the present disclosure.

FIG. 13 is a diagram of a setting pattern according to an exemplary embodiment of the present disclosure.

FIG. 14a is a diagram of a setting pattern according to an exemplary embodiment of the present disclosure.

FIG. 14b is a diagram of a setting pattern according to an exemplary embodiment of the present disclosure.

FIG. 15 is a diagram of a setting pattern according to an exemplary embodiment of the present disclosure.

FIG. 16 is a diagram of a setting pattern according to an exemplary embodiment of the present disclosure.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements. Although features may be shown as separate, such features may be implemented together or individually. Further, although features may be illustrated in association with an exemplary embodiment, features for one or more exemplary embodiments may be combinable with features from one or more other exemplary embodiments.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of a control method of a mobile device using a setting pattern and a mobile device using the method thereof will be described in detail with reference to the accompanying drawings.

The term “mobile device” as used herein will be described briefly.

The mobile device may be implemented in various ways and may have various to features. The mobile device may be any device in which an application program may be operated, and its configuration is not limited. The mobile device may be a smart phone, a smart pad, etc., and may include at least one of a display, a touch sensor, a motion sensor, an oscillator, a speaker, a communication unit, or the like. Further, although described as a mobile device, aspects of the present invention may be applied to smart appliances, such as, for example, a is refrigerator including a display, etc.

The mobile device may include a processing system which includes, for example, a processor, an operating system, and an application program interface (API) to communicate between at least one application program and the operating system.

The processing system of the mobile device may be configured to execute various application programs. The mobile device may communicate with an object, and the mobile device may include hardware and/or software for communication.

The communication method may include communication methods for networking between objects, but is not limited thereto, such as, wired communication, wireless communication, 3G, 4G, or subsequent generations, if a communication function is ensured. Transmittable information, such as, information about various sensors in the mobile device, voice information, and data information may be transmitted to or received from an external object through the mobile device.

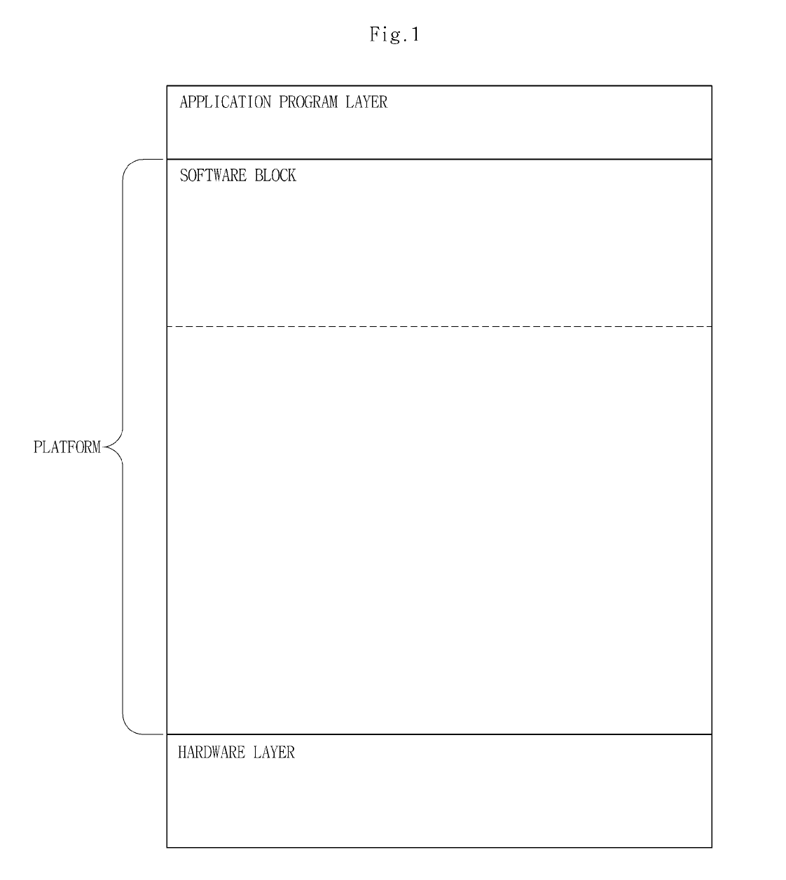

FIG. 1 is a schematic view of an operating system of the mobile device according to an exemplary embodiment of the present disclosure.

Referring to FIG. 1, the operating system of the mobile device includes an application program layer, a platform, and a hardware layer. The platform may be classified into an Android™ platform, a Windows Mobile™ platform, an iOS™ platform or the like according to the operating system of the mobile device, and these platforms may have similar features even though they have somewhat different configurations.

The Android platform may include a Linux kernel layer to manage various hardware, to transfer a request of an application program to a hardware, and to transfer the response of the hardware to the application program, a library layer to connect the hardware to a is framework layer, and a framework layer to manage various application programs. The library layer may be written in C, C++, etc.

The Windows Mobile™ platform may include a Windows core layer which may correspond to the Linux kernel layer, and an interface layer to connect the core layer to an application program layer, and to support various languages or features.

The iOS platform may include a core OS layer which may correspond to the Linux kernel layer, a core service layer which may be similar to the library layer and the framework layer, a media layer to provide a multimedia feature, and a core touch layer of various application programs.

The mobile device of the exemplary embodiments may be implemented in one or more of the aforementioned platforms of mobile devices, but is not limited thereto.

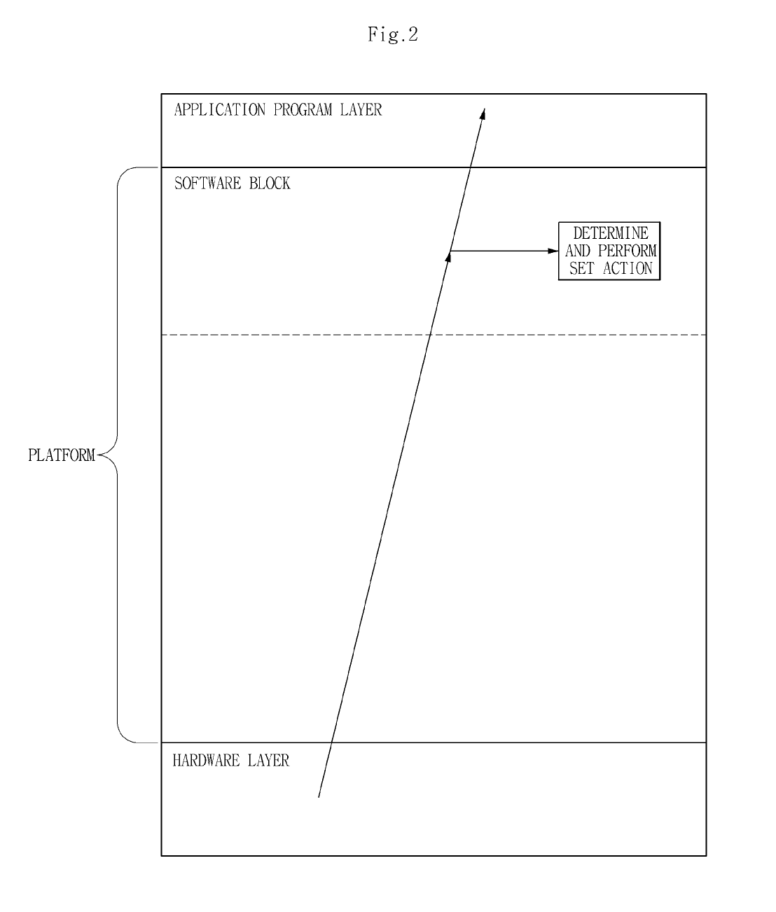

The operating principle of the application program layer according to a touch input of a user will be described with reference to FIG. 2. FIG. 2 is a schematic view of a delivery system of an input signal according to an exemplary embodiment of the present disclosure.

For example, a user may touch a region corresponding to a dialing feature displayed on a touch panel of a hardware layer to use a dialing feature. A touch input signal may be converted into software touch data including information, such as, a coordinate of the touch, a speed of the touch in the touch driver of the platform layer. The software touch data may be transferred to a software block to be transferred to an application program which may be operating in a foreground, by a controller for operating an application program associated with the dialing feature. The application program may perform a process according to the corresponding a touch pattern and/or a touch input.

An application program having the dialing feature may perform a dialing action in response to the touch input of the user. The application program having the dialing feature may perform actions, such as, inputting numbers for dialing, searching phone numbers, dialing, making a video telephone, recording telephone conversation, or the like.

Actions, such as, back light settings, aspect ratio conversion, screen enlargement or reduction, or the like may not be performed by the dialing features. However, performing such an action may be desired, for example, if inputting numbers or searching phone numbers is performed in a dark place, the lighting of the touch panel may turn off after a set time. Therefore, performing one of the above features, such as, back light settings may be desired.

Features not called by the application program but which may be commonly applicable to the application program may be referred to as set actions. A set action may be an action of adjusting a feature of the mobile device. The set actions may or may not be available for a reference application program. If available for an application program, the set actions may be input in different ways for various application programs. Although exemplary embodiments set forth a technique for performing a set action with the same gesture regardless of the kinds of application programs, the exemplary embodiments are not limited thereto and the set action may be performed according to different gestures and different application programs.

FIG. 2 is a schematic view of a delivery system of an input signal according to an exemplary embodiment of the present disclosure. An operating principle of a setting command which may be executed in a setting pattern will be described with reference to FIG. 2.

If a touch input signal corresponding to the setting pattern is detected, the touch input signal may be processed in the platform. For example, the touch panel may sense the touch input, and the touch driver may convert the touch input into the software touch data. The is software touch data may be transferred to the application program layer and the software block. The application program may determine whether the setting pattern corresponding to the software touch data is a touch input related to the application program, and the software block may determine whether the setting pattern is a setting pattern regulated by a user. The application program may ignore the touch input of the user if the software touch data is different from the regulated touch input, and may perform a feature corresponding to the touch input if the transferred touch data is the same as or substantially similar to the regulated touch input. The software block may ignore the touch input of the user if the software touch data is different from the setting pattern, and may perform a set action corresponding to the setting pattern if the software touch data is the same as or substantially similar to the setting pattern.

Before utilizing the software touch data in the application program layer, the software block may determine whether the software touch data input by the software block is a reference setting pattern. If the software block determines that the software touch data is the reference setting pattern, the set action corresponding to the setting pattern may be performed. The set action may be performed before the application program executes the software touch data. The reference pattern may be determined as a common touch pattern having no relation with the application program.

Since the software block separately determines whether the touch input signal of the user corresponds to a setting pattern, the user may perform a preset feature by inputting the common touch pattern regardless of the application program which is operating in the foreground.

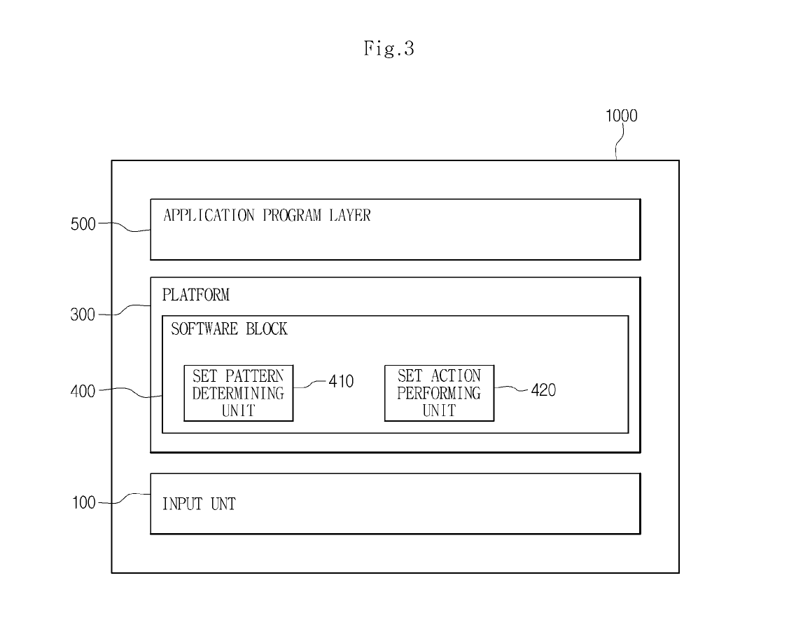

FIG. 3 is a schematic view of a mobile device according to an exemplary embodiment of the present disclosure. Referring to FIG. 3, a configuration to control the mobile is device will be described briefly.

A mobile device 1000 may include an input unit 100, a platform 300, and an application program layer 500. The input unit 100 may receive a touch input signal of a user. The input unit 100 may include hardware, such as, a touch panel, a microphone, a camera, or the like. The input received by the touch unit 100 may be various inputs which may be transferred to the mobile device 1000 by the user, such as, a touch input, but are not limited to a touch input. Hereinafter, the mobile device will be described as if the touch input is a touch pattern input to the touch unit 100, but the exemplary embodiments are not limited thereto.

The touch input signal received by the input unit 100 may be converted into software touch data at a platform 300 and may be transferred to a software block 400 which connects an application program layer 500 to the input unit 100.

A setting pattern determining unit 410 may determine whether the touch input signal is substantially similar to a setting pattern. A set action performing unit 420 may be configured to execute set an action corresponding to the setting pattern. The setting pattern determining unit 410 and the set action performing unit 420 may be configured in the software block 400.

The set action may have a one-to-one relation with the setting pattern, and the set action may be set in the mobile device as a default value or may be set, or corrected, or adjusted by the user.

In the Android platform, the touch input signal received through the input unit 100 may be transferred to the Linux kernel layer, which may be one of the layers of the platform 300, and may be converted into software data. The Linux kernel layer may manage one or more of hardware, internal memory, processes, networking, power, or the like of the mobile device 1000.

The software touch data converted in the Linux kernel may be transferred to the library layer. The library layer may connect various kinds of hardware corresponding to the input unit 100 with a framework layer corresponding to the software block 400. The library may include a Dalvik virtual machine which is a register-based machine, but is not limited thereto. The Dalvik virtual machine may play a run-time role of operating the application program under the Android operating system. The software touch data converted in the Linux kernel may be transferred via the Dalvik virtual machine to the framework layer.

The framework layer may transfer the software touch data to the application program which may be operating in the foreground and may compare the received software touch data with the setting pattern. If software touch data is the same as or substantially similar to the setting pattern, the framework layer may perform a set action corresponding to the setting pattern. The framework layer may include the setting pattern determining unit 410 to determine whether the software touch data is substantially similar to the setting pattern and a set action performing unit 420 to perform a set action corresponding to the setting pattern. The framework layer may provide features necessary to execute the application program. The set action will be described in detail below.

The application program layer 500 may include various application programs to which may be implemented in the mobile device 1000, for example web browsers, short message service (SMS), IMS, video telephone, map, navigation, or the like.

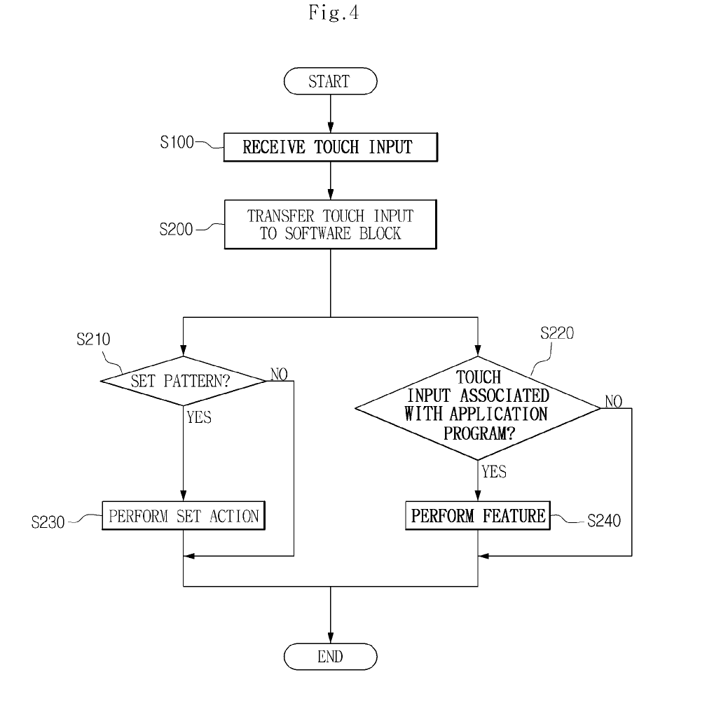

FIG. 4 is a flowchart of a control method of a mobile device according to an exemplary embodiment of the present disclosure.

In operation S100, the mobile device may receive a touch input of a user through is a touch panel. The touch panel may be hardware and software to generate a touch input signal according to the touch input. The touch input signal may be converted into software touch data to allow software processing. In operation S200, the software touch data is transferred to a software block of the mobile device. The software touch data may be transferred through the software block to an application program which is operating in the foreground and may be processed in the software block. The software touch data may be transferred to the application program and processed in the software block substantially simultaneously, i.e., operations S210 and S220 may occur substantially simultaneously.

In operation S210, the software block may determine whether the touch pattern input by the user is the same as or substantially similar to a setting pattern. If the software touch data is the same as or substantially similar to the setting pattern, in operation S230, the software block may perform a reference set action. The set action may be one of an action to execute a setting menu of the mobile device, an action to perform a feature of the mobile device predetermined or selected by the user, and an action to perform a feature of an application program selected by the user. For example, actions, such as, adjusting lighting settings, adjusting aspect ratio conversion, screen enlargement, screen reduction, or the like may be performed.

If the software touch data is different from the setting pattern, the touch input of the user is ignored.

In operation S220, the application program which may be operating in the foreground determines whether the software touch data is substantially similar to a touch input signal of the application program. If the software touch data is substantially similar to the touch input signal of the application program, in operation S240, a feature corresponding to the touch is input signal may be performed. If the software touch data is different from the selected touch input signal, the touch input of the user is ignored.

The determination of the software block and the determination of the application program which may be operating in the foreground may be performed substantially at the same time. The touch input signal of the application program may be set to not overlap with the setting pattern. Therefore, the above determination of the software block and the determination of the application program may be performed at the same time.

If the software block determines that the input of the user is the setting pattern and performs the set action, the touch input of the user may not be transferred to the application program.

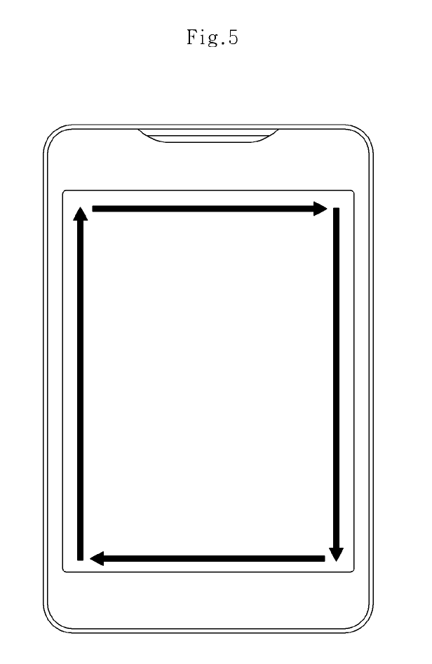

Referring to FIG. 5 through FIG. 16, various features which may be operated by using the setting pattern will be described. Set actions which may be performed according to the setting pattern will be described. However, the relation between the setting pattern and the set action are not limited thereto, and the set actions may be changed to correspond to a different setting pattern. In other words, the exemplary embodiments of the setting pattern do not limit the relation between a setting pattern and a set action.

FIG. 5 is a diagram of a setting pattern according to an exemplary embodiment of the present disclosure. The setting pattern is a touch pattern in which an upper edge, a lower edge, a right edge, and a left edge of the touch panel are touched and dragged and may be touched and dragged consecutively. The set action corresponding to the setting pattern of FIG. 5 may be an action of accepting touch inputs received in a bezel area. The bezel area may be the portion of the display area surrounding the upper edge, the lower edge, the right edge, and the left edge of the touch panel. According to exemplary embodiments, the setting pattern may is include a portion in which a bezel portion surrounding the touch panel is touched and dragged. A touch sensing element may not been present in the bezel portion, and, even if a touch sensing element is present in the bezel area, the touch input at the bezel portion has been generally ignored. However, according to aspects of the present invention, the feature of receiving a touch input in the bezel portion may be used. Further, the edges may be touched and dragged in a clock-wise or counter clock-wise direction and may be touched and dragged consecutively or non-consecutively.

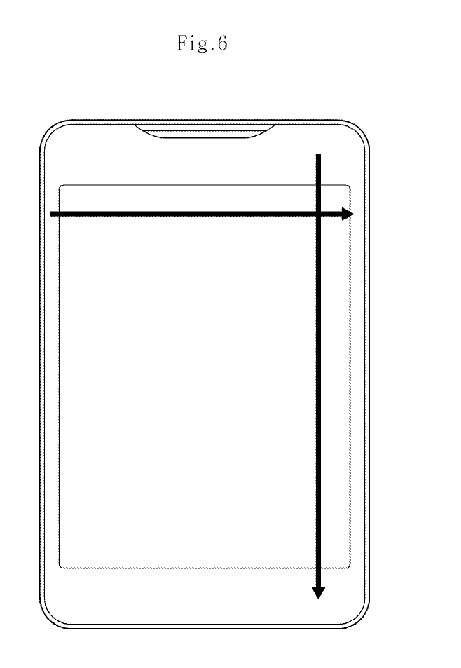

FIG. 6 is a diagram of a setting pattern according to an exemplary embodiment of the present disclosure. FIG. 6 illustrates a setting pattern is a touch pattern in which an upper edge and a right edge of the touch panel are touched and dragged and may be touched and dragged consecutively. In particular, at least a portion of the bezel portion surrounding the touch panel may be touched and dragged. For example, this may include a case in which the touch pattern starts from a bezel portion, a case where the touch pattern starts from a bezel portion and ends at a bezel portion after passing over a touch portion of the panel, a case in which the touch pattern starts from a touch portion of the touch panel and ends at a bezel portion of the touch panel, or the like.

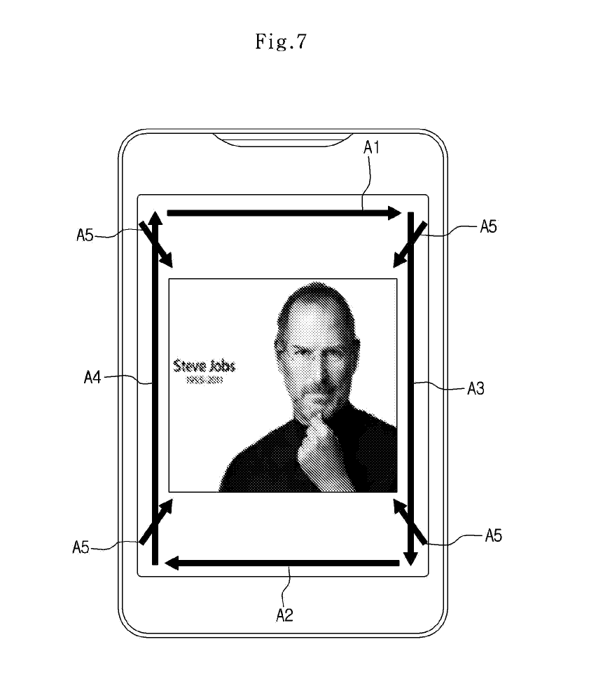

FIG. 7 is a diagram of a setting pattern according to an exemplary embodiment of the present disclosure. FIG. 7 illustrates a touch pattern in which the upper edge, the lower edge, the right edge, and the left edge are touched and dragged similar to the touch pattern illustrated in FIG. 5. As shown in FIG. 7, the touch and drags A1, A2, A3, and A4 on the upper edge, the lower edge, the right edge, and the left edge, respectively, operate to decrease a size of an active region used by an application program operating in the foreground as indicated by arrows A5. A bezel portion of the touch panel and an inactive region of the touch panel, in which an is application program operating in the foreground does not use, may be touched in the touch pattern. The touch pattern of FIG. 7 may correspond to a set action of reducing an active region of the application program, i.e., shrinking the application program on the touch panel. If the active region of the application program is decreased in size, a touch pattern may be input to an inactive region of the touch panel surrounding the active region of the application program. If the setting pattern of FIG. 7 is input, a set action may be set to correspond to the setting pattern, such as, turning on a backlight of the mobile device 1000, which may be a feature with no relation to the feature of the application program operating in the foreground.

FIG. 8 is a diagram of a setting pattern according to an exemplary embodiment of the present disclosure. The setting pattern of FIG. 8 is a touch pattern representing a text and may correspond to a set action of making a call or sending a text message to a selected phone number. For example, if a touch pattern is input to a mobile device by touching and dragging the touch panel to form a text of “SOS,” a set action of making an emergency call or sending a text message to a stored phone number may be performed. Even if any application program is operating in the foreground of the mobile device 1000 or the mobile device 1000 is in a sleep mode, the emergency call feature may be performed through a set action controlled not by the software block, not the application program. Further, although “SOS” is shown as being input linearly, aspects need not be limited thereto such that the “S”, “O”, and “S” may be overlapped. Moreover, the stored touch pattern may be a contact's initials, and if a contact's initials are input to the mobile device, a call may be placed or a text message sent to the corresponding contact.

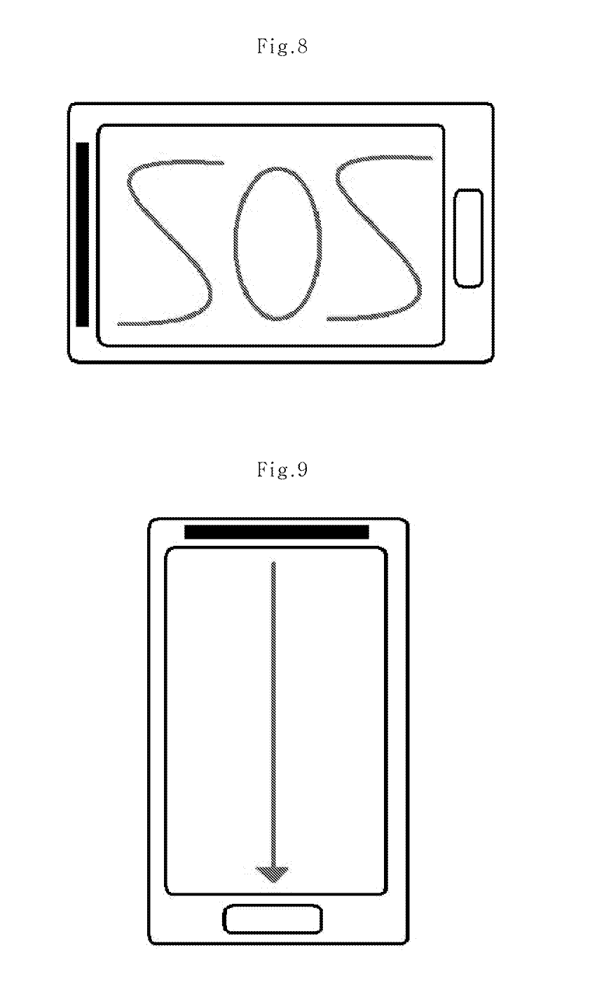

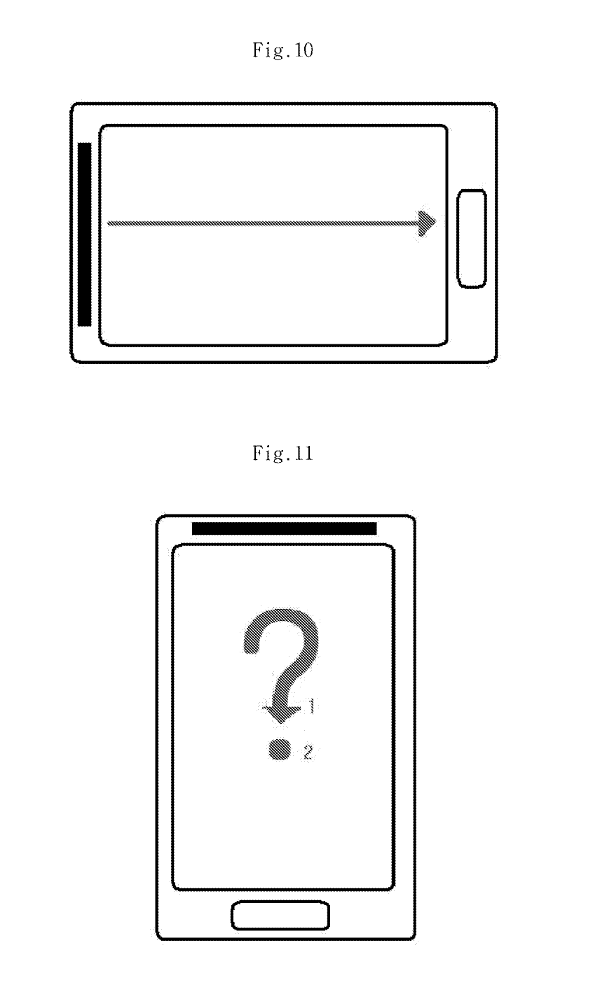

FIG. 9 is a diagram of a setting pattern according to an exemplary embodiment of the present disclosure. FIG. 10 is a diagram of a setting pattern according to an exemplary embodiment of the present disclosure. The set patterns of FIG. 9 and FIG. 10 are touch patterns is of touching and dragging from one edge to an opposite edge of the mobile device 1000. If a mobile device 1000 is operated in a horizontal mode or vertical mode, the setting patterns of FIG. 9 and FIG. 10, respectively, may correspond to a set action to switch the screen display of the mobile device 1000. Generally, the screen of a mobile device 1000 may be shifted to a horizontal mode or vertical mode using a gyro-sensor feature of the mobile device 1000, but if the length and width of the contents are oriented upside down or sideways or if the gyro-sensor feature is disabled, the orientation of the screen may be manually implemented by a set action controlled by the software block.

FIG. 11 is a diagram of a setting pattern according to an exemplary embodiment of the present disclosure. The setting pattern of FIG. 11 is a touch pattern which symbolizes a question mark, including the stroke 1 and the dot 2, and may correspond to a set action of displaying a search window. A web browser may allow searching, but if a user needs a searching feature while another application is operating in the foreground, a search window may be provided so that the user may perform searching at any time. Searching may include searching an application program of a mobile device, web searching, etc. Further, other symbols may be input to perform other operations, for example, a # may be input to access a contact list or past numbers dialed; a $ may be input to access an accounting application or website; etc.

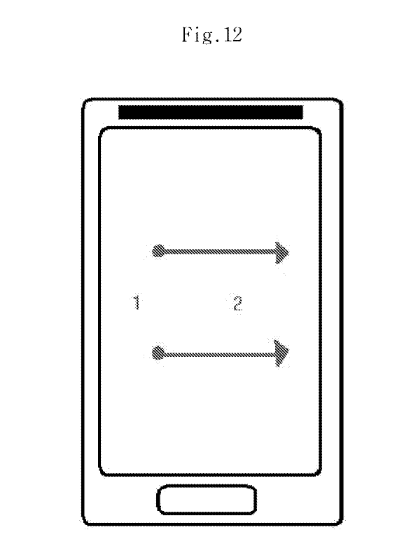

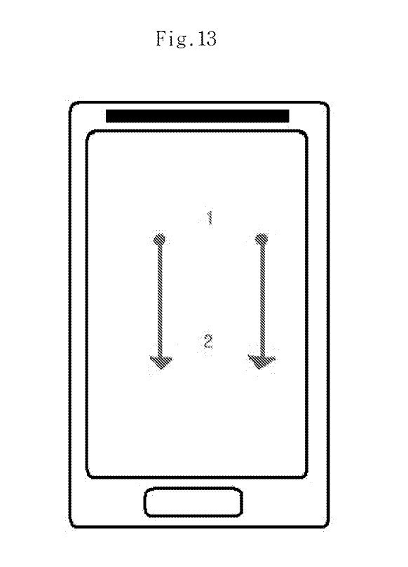

FIG. 12 is a diagram of a setting pattern according to an exemplary embodiment of the present disclosure. FIG. 13 is a diagram of a setting pattern according to an exemplary embodiment of the present disclosure. The setting patterns of FIG. 12 and FIG. 13 are touch patterns in which two touch flicking patterns are performed from area 1 to area 2, for example, using two fingers, which may be associated with a set action of arranging another application program to a higher rank among application programs running as a background in the touch pattern. A set action of turning up the volume or turning down the volume may correspond to the setting patterns of FIG. 12 and FIG. 13, respectively. Further, such actions may be distinguishable according to an orientation of the terminal.

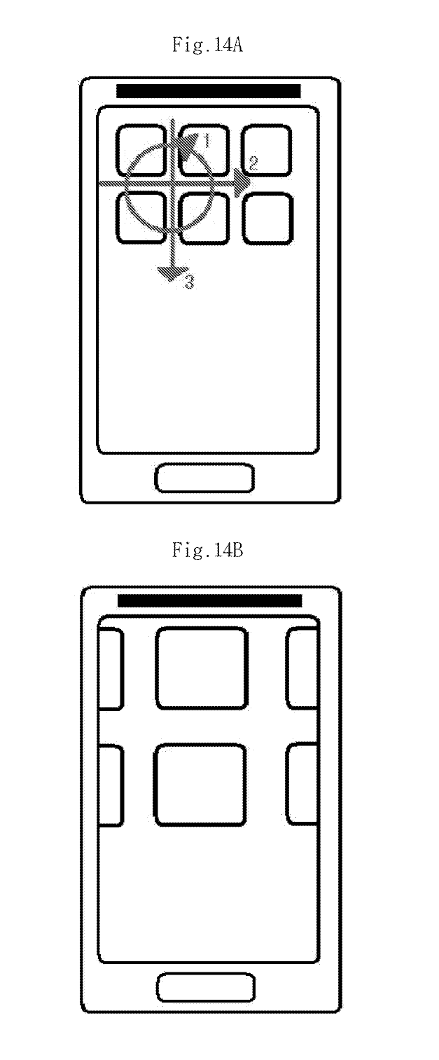

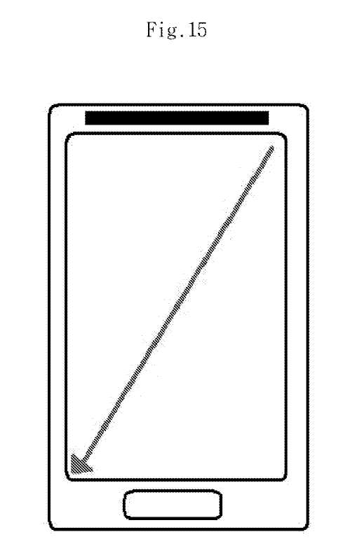

FIG. 14a is a diagram of a setting pattern according to an exemplary embodiment of the present disclosure. FIG. 14b is a diagram of a setting pattern according to an exemplary embodiment of the present disclosure. The setting pattern of FIG. 14a may use a combination of a circular touch pattern 1 which encircle a portion of the touch panel, and a horizontal line touch pattern 2 and a vertical line touch pattern 3 which interest inside the circular touch pattern to correspond to a set action of enlarging the intersected point, i.e., zooming in on the intersected point. FIG. 14b illustrates the zoomed in intersected point of FIG. 14a. According to application programs, the enlargement feature or reduction feature may be restricted. However, by using the setting pattern, the enlargement feature or reduction feature provided by the framework layer may be used regardless of the attributes of the application program.

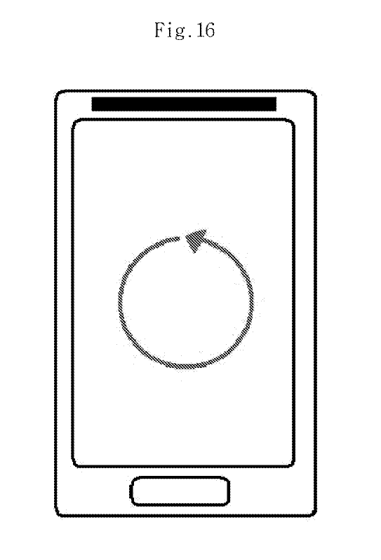

FIG. 15 is a diagram of a setting pattern according to an exemplary embodiment of the present disclosure. FIG. 16 is a diagram of a setting pattern according to an exemplary embodiment of the present disclosure. The setting pattern of FIG. 15 is a touch pattern in which a diagonal line is touched and dragged, which may correspond to a set action of forcibly stopping the operating application program. Further, a touch pattern in which diagonal lines are touched and dragged, or touched and dragged consecutively, correspond to a set action of forcibly stopping the operating application program. The setting pattern of FIG. 16 is a circular touch pattern, which may correspond to a set action for shifting to a menu screen.

According to exemplary embodiments, regardless of the application program operating in the foreground of the mobile device 1000, by using setting patterns in various ways, is a feature desired by the user may be performed.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed:

1. A method for controlling a device, comprising:
receiving a touch input in the device;
determining if the touch input is a set pattern corresponding to a set action of the device;
executing the set action of the device, if the touch input corresponds to the set pattern,
wherein the set action is an action of adjusting a feature of the device.

2. The method of claim 1, further comprising:
determining if the touch input corresponds to a feature of an application program; and
executing the feature of the application program if the touch input corresponds to the feature of the application program.

3. The method of claim 2, wherein the application program is operating in a foreground of the device.

4. The method of claim 2, wherein the set action is at least one of adjusting back light settings, adjusting aspect ratio conversion, screen enlargement, screen reduction, adjusting screen orientation, emergency calling, displaying a search window, adjusting volume, closing the application program, switching between application programs, and screen zooming.

5. The method of claim 1, wherein the set pattern is a pattern formed by at least one of touching and dragging along at least one side edge of a touch panel of the device, a text pattern, a question mark pattern, a touch and flick pattern, a double touch and flick pattern, a circular pattern, and a horizontal pattern.

6. The method of claim 1, wherein the set pattern extends into a bezel area of a touch panel of the device.

7. A method for controlling a mobile device, comprising:
receiving a touch input signal in the mobile device;
transferring the touch input signal to a software block of the mobile device and to an application program;
determining if the touch input signal corresponds to a setting pattern in the software block of the mobile device; and
performing a set action corresponding to the setting pattern if the touch input signal corresponds to the setting pattern,
wherein the set action is an action of adjusting a feature of the mobile device.

8. The method of claim 7, further comprising:
determining if the touch input corresponds to a feature of the application program; and
performing the feature of the application program if the touch input corresponds to the feature of the application program.

9. The method of claim 8, wherein the application program is operating in a foreground of the mobile device.

10. The method of claim 7, wherein the set action is at least one of adjusting back light settings, adjusting aspect ratio conversion, screen enlargement, screen reduction, adjusting screen orientation, emergency calling, displaying a search window, adjusting volume, closing the application program, switching between application programs, and screen zooming.

11. The method of claim 7, wherein the set pattern is a pattern formed by at least one of touching and dragging along at least one side edge of a touch panel of the mobile device, a text pattern, a question mark pattern, a touch and flick pattern, a double touch and flick pattern, a circular pattern, and a horizontal pattern.

12. The method of claim 7, wherein the set pattern extends into a bezel area of a touch panel of the device.

13. A mobile device, comprising:
an input unit to receive a touch input signal;
a setting pattern determining unit to determine if the touch input signal is a setting pattern; and
a set action performing unit to execute a set action corresponding to the setting pattern, if the touch input signal corresponds to the setting action,
wherein the set action is an action of adjusting a feature of the mobile device.

14. The mobile device of claim 13, wherein the set action is performed regardless of an application operating in the mobile device.

15. The mobile device of claim 14, wherein the application program is operating in a foreground of the mobile device.

16. The mobile device of claim 13, wherein the set action is at least one of adjusting back light settings, adjusting aspect ratio conversion, screen enlargement, screen reduction, adjusting screen orientation, emergency calling, displaying a search window, adjusting volume, closing the application program, switching between application programs, and screen zooming.

17. The mobile device of claim 13, wherein the set pattern is a pattern formed by at least one of touching and dragging along at least one side edge of the input unit of the mobile device, a text pattern, a question mark pattern, a touch and flick pattern, a double touch and flick pattern, a circular pattern, and a horizontal pattern.

18. The mobile device of claim 13, wherein the set pattern extends into a bezel area of the input unit of the device.
